(19) United States
(12) Patent Application Publication
(10) Pub. No.: US 2006/0090431 A1
(43) Pub. Date: May 4, 2006

(54) Filter assembly with combination filter element

(75) Inventor: Gene W. Brown, Franklin, TN (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6780, US

(73) Assignee: Baldwin Filters, Inc., Kearny, NE (US)

(21) Appl. No.: 10/979,401

(22) Filed: Nov. 2, 2004

(51) Int. Cl. B01D 50/00

(52) U.S. Cl. 55/482

(57) ABSTRACT

A filter assembly including a combination filter element for double filtration of air or other gasses is provided. The combination filter element includes a first filter medium and a second filter medium connected together. The first filter medium has an upstream face, a spaced-apart downstream face, and a plurality of channels extending therebetween. The second filter medium is located adjacent the downstream face. Gases entering the first filter medium through the upstream face flow in the channels and, upon exiting the downstream face, are directed toward the second filter medium. To connect the first and second filter mediums, a connecting band extends about the peripheries of the mediums.

### FIELD OF THE INVENTION

This invention pertains generally to fluid filtration and more particularly to filter assemblies which include filter housings and removable filter elements.

### BACKGROUND OF THE INVENTION

Filtration devices and systems are employed in a wide range of applications for filtering contaminants from various process fluids. For example, it is known to pass air or similar gases through filter assemblies that enclose filtration media such as filter paper to remove dust and other contaminants. The filtration media is typically enclosed within a housing that is permanently fixated within a larger overall process system that utilizes the filtered air or gas. Desirably, to prevent reduced filtration or clogging, the filter assembly is constructed to facilitate the removal and replacement of the filtration media from the permanently fixated housing. For this reason, the filtration media is typically configured into removable filter elements or filter cartridges. Generally, it is also desirable that the filter assembly occupy a minimum amount of space while still providing sufficient filtration.

### BRIEF SUMMARY OF THE INVENTION

The invention provides a filter assembly and a filter element for use therein that is configured to perform double filtration of a process gas. To perform the double filtration, the combination filter element includes a first filter medium and a second filter medium. The first filter medium has an upstream face, a spaced-apart downstream face, and a plurality of channels defined by filter paper or similar media that extend between the upstream and downstream faces. Gases impinging upon the upstream face pass across the channels and through the downstream face and are thereby filtered of containments. The second filter medium is connected to the first filter medium such that gases exiting the downstream face encounter the second filter medium where further filtration occurs. To connect the first and second filter mediums, a connecting band can extend about the peripheral sides of the filter mediums. The connected first and second filter mediums form a unitary filter element that can be installed in the filter housing.

The filter assembly also provides a filter housing for accommodating the combination filter element. The filter housing and combination filter element are releasably engaged so that the filter element can be removed and replaced. To provide access for the process gases, the filter housing defines an inlet and an outlet. When the combination filter element is installed in the filter housing, the upstream face of the first filter medium is oriented toward the inlet. Accordingly, the second filter medium is oriented toward the outlet so that process gases exiting the second filter medium are directed out of the filter housing.

An advantage of the invention is that it provides a filter assembly and combination filter element configured to perform double filtration of process gases. Another advantage is that the filter element combines first and second filter mediums that may be made of the same or different materials. These and other advantages and features of the present invention will become apparent from the following drawings and detailed description.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a cross-sectional view of a filter assembly including a combination filter element designed in accordance with the teachings of the invention.

FIG. 2 is a perspective view of the combination filter element removed from the filter housing.

FIG. 3 is an exploded view of the combination filter element illustrating the first filter medium, second filter medium, and the connecting band.

FIG. 4 is a perspective view of an embodiment of the second filter medium wherein pleats are arranged in parallel with each other.

FIG. 5 is a perspective view of an embodiment of the second filter medium wherein pleats are arranged radially with each other.

FIG. 6 is a detailed view of the combination filter element taken of the area indicated by circle 6 of FIG. 1.

FIG. 7 is a perspective view of an alternate embodiment of an end cap, according to the invention, including a screen formed integrally with the end cap.

FIG. 8 is a detailed view, corresponding to FIG. 6, of an alternate embodiment of the invention, having an end cap attached directly to a connecting band, according to the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE EMBODIMENTS

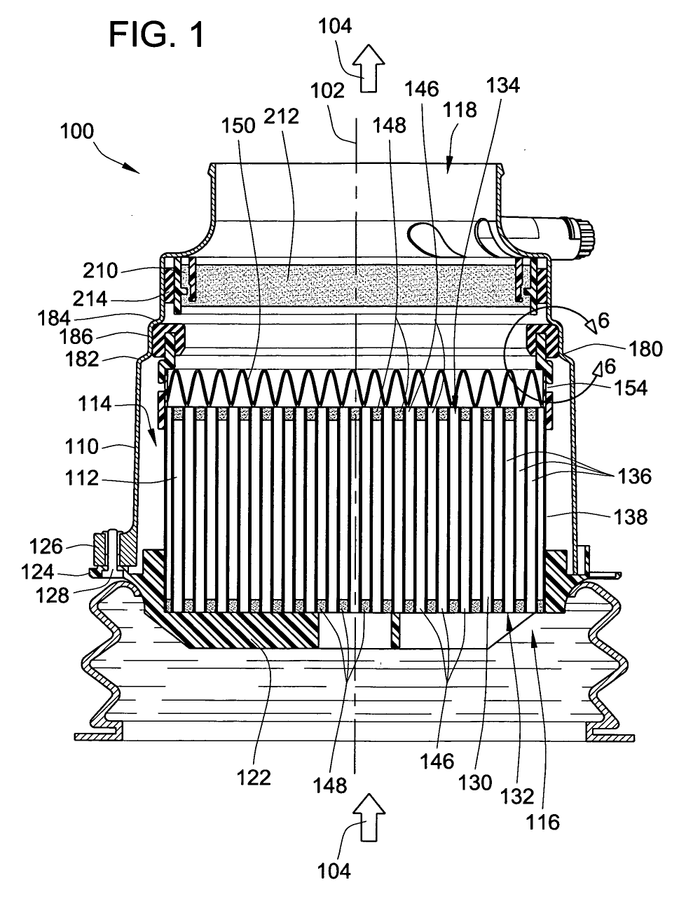

Now referring to the drawings, wherein like reference numerals refer to like features, there is illustrated in FIG. 1 a filter assembly 100 through which fluids and particularly gases such as air, can flow for filtration. The filter assembly 100 includes a filter housing 110 defining an interior volume 114 that can accommodate a combination filter element 112. The filter housing 110 is generally tubular in shape and extends along an axis line 102. To provide access to the interior volume 114, the filter housing 110 also includes an inlet 116 formed at a first end of the tubular housing and an axially spaced-apart outlet 118 formed at a second end of the housing. Because the axially opposed arrangement of the inlet 116 and outlet 118 will cause gases to flow along the direction of the axis line 102 as indicated by arrows 104, this type of filter assembly 100 is often referred to as a “straight-through flow” filter assembly.

To receive the combination filter element 112 in the internal volume 114, the filter element can be axially inserted through the inlet 116 of the filter housing 110. In the preferred and illustrated embodiment, both the filter housing 110 and filter element 112 are generally cylindrical in shape and coaxially arranged about the axis line 102, with the filter housing having a larger diameter than the filter element to provide a sliding or clearance fit. However, as will be appreciated by those of skill in the art, the tubular filter housing 110 and filter element 112 can be provided in other shapes such as, for example, oval and rectangular. Accordingly, all geometric references such as “radial,” “annular,” “diametric,” “concentric,” and the like are exemplary only and are not to be construed as limitations on the invention.

To releasably engage the removable filter element 112 to the filter housing 110, in the illustrated embodiment the filter element includes an inlet cover 122 that extends over the inlet 116 when the filter element is inserted into the internal volume 114. Preferably, the inlet cover 122 includes a plurality of slots or apertures disposed therein to enable fluid flow. The inlet cover 122 also includes one or more radially outward extending flanges 124 that can abut against corresponding flanges 126 located at and projecting from the inlet 116 of the filter housing 110. Threaded fasteners 128 can be threadably received in threaded holes disposed through the respective flanges. Accordingly, to remove a clogged or dirty filter element 112, the threaded fasteners 128 are undone and the filter element is pulled in the axially direction from the filter housing 110.

To perform the double filtration of gases passing through the filter assembly 100, the combination filter element 112 includes a first filter medium 130 and a second filter medium 150 connected together. The first filter medium 130 is attached to the inlet cover 122 and extends axially therefrom when the combination filter element 112 is inserted into the internal volume 114. Moreover, when the filter element 112 is so inserted, the second filter medium 150 is oriented toward the outlet 118. Accordingly, gases from the inlet 116 are directed initially through the first filter medium 130 and subsequently through the second filter medium 150 for double filtration.

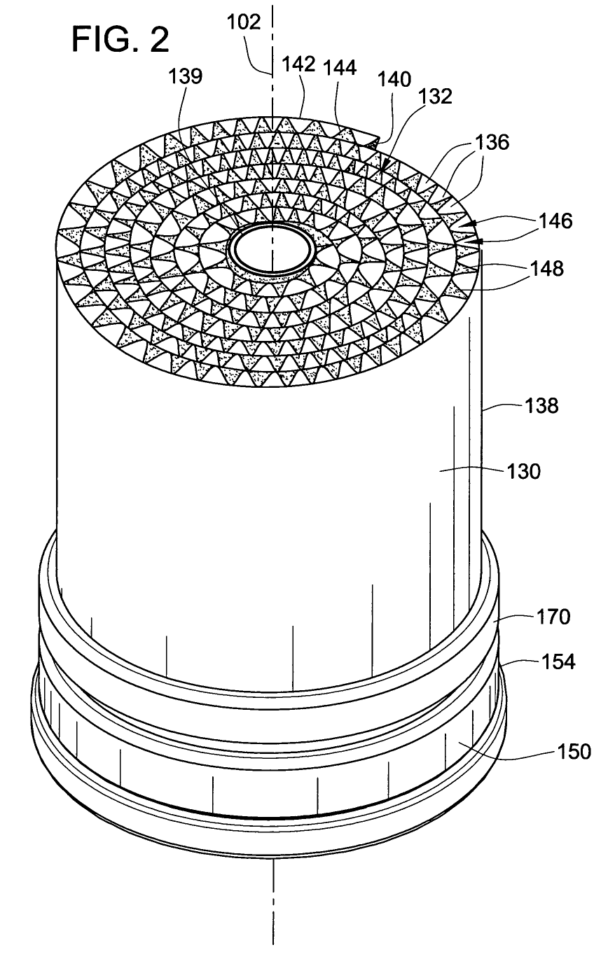

Referring to FIG. 2, there is illustrated the combination filter element 112 as removed from the filter housing. In the preferred embodiment, to provide the cylindrical shape of the filter element 112, both the first and second filter mediums are cylindrical 130, 150 themselves. However, as will be appreciated, in other embodiments the filter mediums can have other shapes corresponding to the overall shape of the filter element. So that the filter element 112 and the filter housing 110 are coaxially aligned when engaged, the filter element is arranged about a common axis line 102 with the first and second filter mediums 130, 150 axially adjacent. Accordingly, as illustrated in FIG. 1 with the preferred shapes, the filter housing 110 and filter element 112 are concentric about the axis line 102.

As illustrated in FIGS. 1, 2, and 3, the cylindrical first filter medium 130 extends between a circular upstream face 132 and a spaced-apart, correspondingly circular downstream face 134. When the filter element 112 is inserted into the filter housing 110, the upstream face 132 is directed toward the inlet 116 while the downstream face is directed toward the outlet 118. The first filter medium 130 also defines a plurality of parallel, fluted channels 136 that extend between the upstream and downstream faces 132, 134. Accordingly, gases flowing in the axial direction indicated by arrow 108 impinge upon the upstream face 132, filtrate through the channels 136, and exit through the downstream face 134. The first filter medium 130 additionally includes a cylindrically-shaped peripheral sidewall 138 extending between the upstream and downstream faces 132, 134.

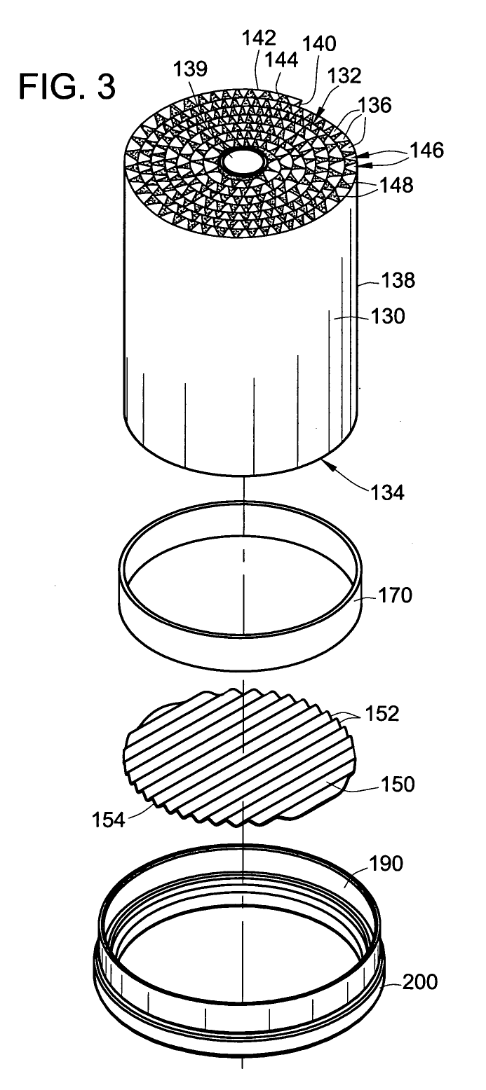

Referring to FIGS. 2 and 3, the first filter medium 130 can be constructed from wound layers of corrugated, multilayered sheet 140. The multilayered sheet 140 is made of a planar layer 142 and a corrugated layer 144, both composed from a gas permeable filter paper material. The corrugated layer 144 is laid over and adhered to the planar layer 142 so that the corrugations define the plurality of fluted channels 136. To produce the cylindrical shape of the filter media 130, the multilayered sheet 140 is spiral wound about a central rod 138 in radially increasing layers so that the channels 136 extend between the upstream and down stream faces 132, 134. In an embodiment, the filter media 130 can be wrapped in an outermost, adhesive layer that holds the spiral wound, multilayered sheet 140 together.

To cause the gases to pass through the planar and corrugated layers of filter paper 142, 144 and thereby remove impurities, each of the fluted channels 136 is configured with either an opening 146 or a plug 148 at its respective upstream and downstream faces 132, 134. For example, as illustrated in FIG. 1, a particular channel 136 that has an opening 146 at the upstream face 132 will also have a plug 148 at the downstream face 134. The adjacent channel will be oppositely configured. Accordingly, gases from the inlet 114 will readily pass into those channels 136 that are unplugged at the upstream face 132. Because those same channels 136 are plugged at the downstream face 134, the gases must proceed through the filter paper layers into a channel unplugged at the downstream face 134. To plug a particular channel, a drop of adhesive can be inserted into the channel.

As illustrated in FIG. 3, the second filter medium 150 is also constructed from one or more layers of a gas permeable filter paper material that is formed with a plurality of aligned pleats 152 that define alternating ridges and dips. Additionally, the second filter medium defines a peripheral edge 156 that, in the preferred embodiment, is circular in shape with about the same diameter as the cylindrical first filter medium 130. When connected to the first filter medium 130, the second filter medium 150 is arranged so that the pleats 152 are perpendicular to the axis line 102.

The gas permeable filter paper material used to make the second filter medium can be the same or different from that used to make the first filter medium. Accordingly, the filter paper material can be selected to filtrate impurities of different sizes or compositions.

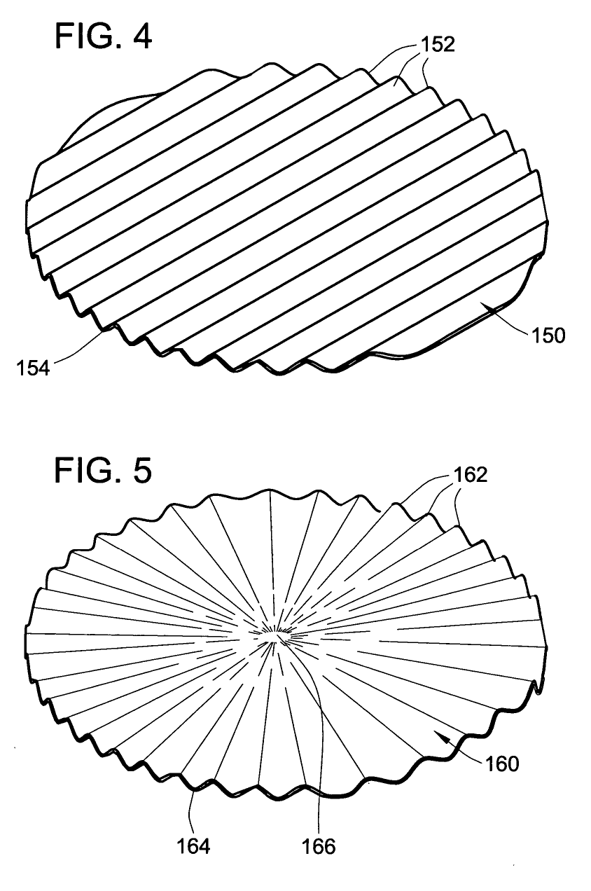

Referring to FIGS. 4 and 5, there is illustrated two different embodiments of the second filter medium. In the first embodiment, the second filter medium 150 has pleats 152 that are aligned in parallel and extend in a side-by-side arrangement. In the second embodiment, the second filter medium 160 has pleats 162 extending radially from a center point 166 to the circular peripheral edge 164. Preferably, the center point corresponds to the axis line 102 of the rest of the filter assembly.

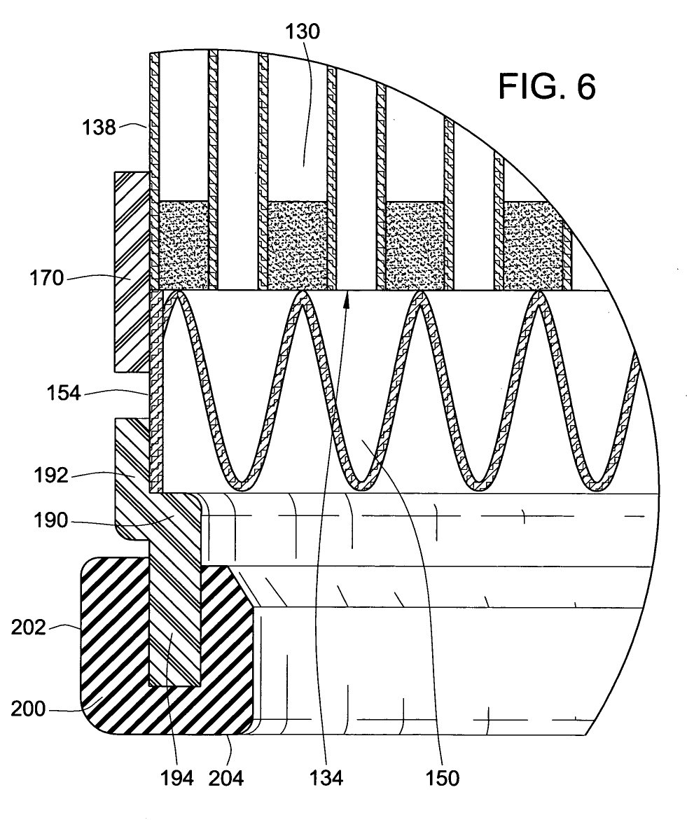

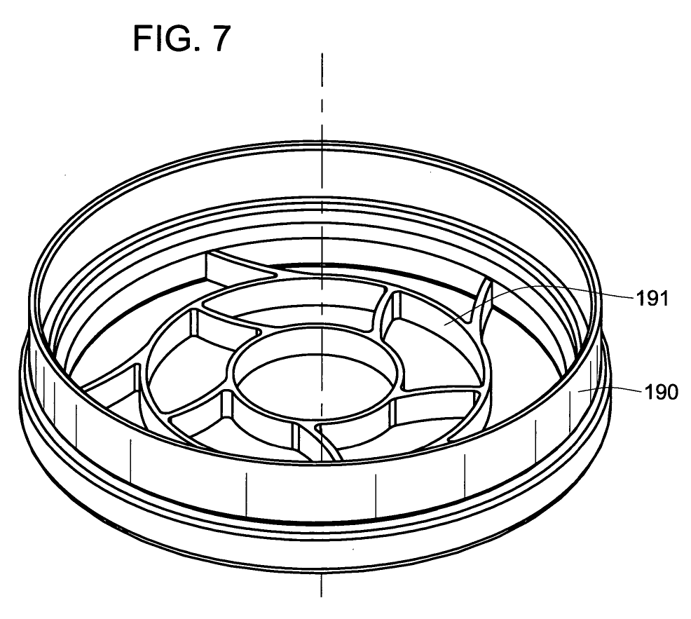

When connected together, as illustrated in FIGS. 2 and 3, the second filter medium 150 is placed axially adjacent to the downstream face 134 of the first filter medium 130. To connect the first and second filter mediums 130, 150 together, a connecting band 170 is provided. The connecting band 170 can be made from any suitable material including, for instance, molded thermoplastic or an elastic material. Furthermore, in the preferred embodiment, the connecting band 170 is annular in shape and arranged concentrically with the axis line 102. The connecting band 170 is sized to produce a slight interference fit with the peripheral sidewall 138 of the first filter medium 130 and with the peripheral edge 154 of the second filter medium 150. Accordingly, as illustrated in FIG. 6, the connecting band 170 contacts and extends about the peripheral sidewall 138 and peripheral edge 154 connecting the first and second filter mediums 130, 150 together to provide a unitary filter element 112. Because of the interference fit between the connecting band 170 and the first and second filter mediums 130, 150, displacement between filter mediums arising because of axial forces generated by flowing gases is prevented. Preferably, when connected, the second filter medium 150 directly contacts and extends across the downstream face 134 of the first filter element 130.

Referring to FIG. 2, because the connecting band 170 connects the first and second filter mediums together, the combination filter element 112 provides a unitary device capable of double filtration. The unitary nature of the filter element 112 facilitates simultaneous handling and replacement of the two filter mediums 130, 150.

Referring to FIG. 1, to facilitate removal of the combination filter element 112 from the filter housing 110, the filter element and filter housing are dimensioned to provide a clearance fit. To ensure that gases flow through the combination filter element 112 rather than any unoccupied portion of the internal volume 114 remaining between the filter element and the tubular filter housing 110, the filter element is configured to abut against a stepped surface 180 of the filter housing. The stepped surface 180 includes a first annular shoulder portion 182 and a second annular shoulder portion 184 that are axially spaced-apart by an annular intermediate portion 186. The first and second shoulder portions 182, 184 and the intermediate portion 186 are all concentric about the axis line 102 with the intermediate portion extending between the shoulder portions in a generally parallel orientation with the axis line. In the preferred embodiment, the stepped surface 180 radially reduces the diameter of the cylindrical filter housing 110.

Referring to FIGS. 1 and 6, to abut the combination filter element 112 with the stepped surface 180 in a substantially gas tight manner without damaging the second filter medium 150, the filter element also includes a rigid end cap 190 and a compressible seal element 200. The end cap 190 and seal element 200 are, in the preferred embodiment, both annular in shape and extend about the axis line 102. The rigid end cap 190 includes a first leg 192 that extends adjacent to the peripheral edge 154 and a second leg 194 located radially inward and extending axially beyond the second filter medium 150. The compressible seal element 200 is formed about second leg 194 by, for example, molding, and defines a radially outward directed sealing surface 202 and an axially directed top surface 204. Accordingly, when the combination filter assembly 112 is inserted in the filter housing 110, the sealing surface 202 contacts the intermediate portion 186 while the top surface 204 contacts the second shoulder 194 thereby providing a seal.

Those having skill in the art will recognize that, in some embodiments of the invention, it may be desirable to include provisions, at the outlet of the second filter medium 150, for structurally supporting the removable filter element 112 against axial movement that might occur due to abnormally high air pressure forces acting against the removable filter element 112, such as might be encountered if the filter element 112 should become plugged with water or particulate matter. As shown in FIG. 7, an alternate embodiment of the end cap 190 may include a screen 191 extending across the outlet of the second filter medium 150, to provide support for resisting such potential axial movement of the filter element 112.

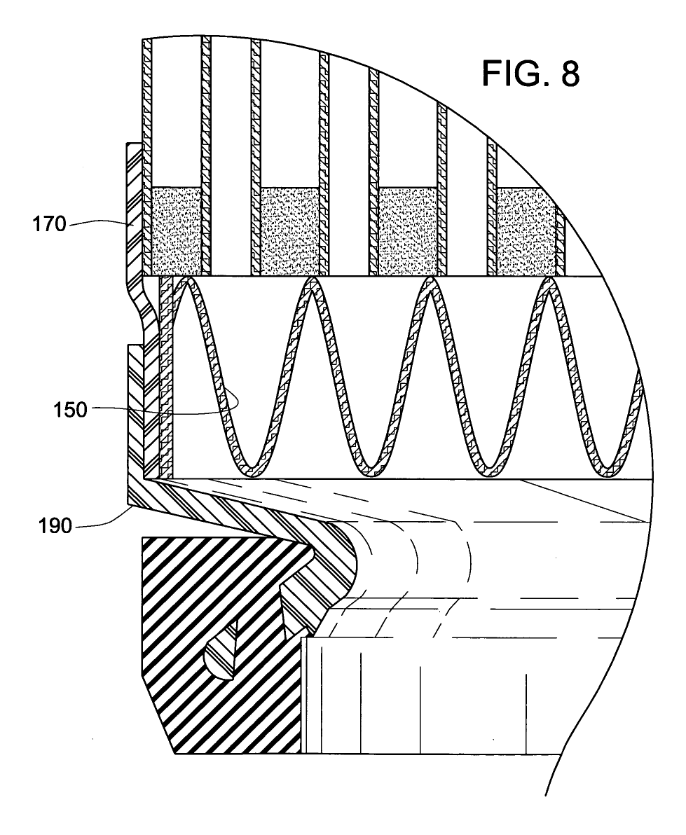

Alternatively, in some embodiments of the invention where it is desired to include provisions at the outlet of the second filter medium 150, to structurally support the removable filter element 112 against axial movement, the second filter medium 150 of the invention may be utilized to structurally support the filter element 112 against axial movement. In an embodiment as shown in FIG. 8, for example, the connecting band 170 and end cap 190 are configured to overlap one another, and are attached to one another by an adhesive bond, or other methods such as welding, staking, or a mechanical connection such as a threaded or a snap connection. By virtue of this arrangement, the second filter medium 150 is securely clamped along the peripheral edge thereof between the downstream face 134 of the first filter medium 130 and the end cap 190.

By configuring the second filter medium 150 in a manner that provides structural rigidity in a direction perpendicular to the axis 102, the second filter medium can provide the desired structural support against axial movement of the unitary filter element 112, in the same manner as the screen 191 shown in FIG. 7. For example, where the second filter medium 150 is a pleated medium having pleats 152 arranged in a parallel, side-by-side arrangement, as shown in FIG. 4, the second filter medium 150 will inherently have structural rigidity in a direction perpendicular to the axis 102, by virtue of the shape and orientation of the pleats 152.

It will also be recognized that, in many embodiments, such as those shown in FIGS. 1-6, and applications of the invention, the second filter medium 150 can be utilized for providing structural support against axial movement of the unitary filter element 112, even without having the end cap 190 and connecting band 170 directly connected, in the manner described above in relation to FIG. 8.

The invention provides a further advantage, with regard to withstanding axial pressure forces on the filter element 112, in that the first and second filter mediums 130, 150 can be configured in a complimentary manner to provide a desirable pressure drop characteristic through the unitary filter element 112. For example, it may be desirable to configure the first and second filter mediums 130, 150 such that the majority of the pressure drop thorough the unitary filter element 112 occurs in the second filter medium 150, rather than in the first filter medium 130. Such a division of pressure drop may be desirable to reduce the axial pressure force that must be resisted by the first filter medium 130, in the event that the filter element 112 becomes clogged. Reducing the axial pressure force on the first filter medium 150 lessens the likelihood that the pressure force on the first filter medium 130 will cause the spiral-wound layers of the first filter medium 130 to separate from one another and telescope outward from the downstream face 134, in a downstream direction along the axis 102, in a typical failure mode well known to those having skill in the art.

Referring to FIG. 1, in various embodiments, the filter assembly 100 can include a separate safety filter element 210 composed of a third filter medium 212. The safety filter element 210 is located axially downstream of the combination filter element 112 and extends across the outlet 118 of the filter housing 110. Gases exiting the second filter medium 150 are therefore directed to the safety filter element for further filtration prior to exiting the filter assembly. To retain the safety filter element 210, a second compressible seal element 214 can extend between the peripheral sides of the safety filter medium 212 and the filter housing 110. As will be appreciated in FIG. 1, to access the safety filter element 210, the combination filter element 112 must first be removed from the internal volume 114.

Thus, the invention provides a combination filter element for use in a filter assembly that provides double filtration of process gases. The combination filter element includes a first filter medium and a second filter medium connected together by a connecting band to provide a unitary filter element.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter assembly for double filtration comprising:
a tubular filter housing including an inlet and an outlet;
a combination filter element including:
a first filter medium having an upstream face, a downstream face, and a plurality of channels extending between the upstream and downstream faces, and
a second filter medium connected to the first filter medium by a connecting band.

2. The filter assembly of claim 1, wherein the inlet and the outlet are disposed along an axis line.

3. The filter assembly of claim 2, wherein the second filter medium is formed with a plurality of pleats and connected to the first filter medium such that the pleats are generally perpendicular to the axis line.

4. The filter assembly of claim 3, wherein the pleats are arranged in parallel.

5. The filter assembly of claim 3, wherein the pleats are arranged radially.

6. The first assembly of claim 2, wherein the upstream face is directed toward the inlet and the second filter medium is directed toward the outlet.

7. The filter assembly of claim 1, wherein the second filter medium adjacently contacts the downstream face of the first filter medium.

8. The filter assembly of claim 1, wherein the first filter medium has a peripheral sidewall and the second filter medium has a peripheral edge, the connecting band forming an interference fit with the peripheral sidewall and the peripheral edge.

9. The filter assembly of claim 8, wherein the peripheral sidewall is cylindrical, the peripheral edge is circular, and the connecting band is annular.

10. The filter assembly of claims 9, wherein the connecting band is comprised of a thermoplastic.

11. The filter assembly of claim 10, wherein the connecting band is comprised of a elastomeric material.

12. A combination filter element for double filtration comprising:
a first filter medium a first filter medium having an upstream face, a downstream face, and a plurality of channels extending between the upstream and downstream faces, and
a second filter medium connected to the first filter medium by a connecting band.

13. The combination filter element of claim 12, wherein the first filter medium and second filter medium are disposed along an axis line.

14. The combination filter element of claim 13, wherein the second filter medium is formed with a plurality of pleats and connected to the first filter medium such that the pleats are generally perpendicular to the axis line.

15. The combination filter element of claim 14, wherein the second filter medium adjacently contacts the downstream face of the first filter medium.

16. The combination filter element of claim 15, wherein the first filter element is cylindrical, the second filter element is circular, and the connecting band is annular.
